(19) United States
(12) Patent Application Publication
(10) Pub. No.: US 2020/0327524 A1
(43) Pub. Date: Oct. 15, 2020

(54) SYSTEM AND METHOD THAT MODIFIES A TRANSACTION AMOUNT AT A POINT OF SALE

(71) Applicant: Michael Nardy, Sag Harbor, NY (US)

(72) Inventor: Michael Nardy, Sag Harbor, NY (US)

(21) Appl. No.: 16/722,758

(22) Filed: Dec. 20, 2019

Related U.S. Application Data
(60) Provisional application No. 62/752,810, filed on Oct. 30, 2018.

(51) Int. Cl. G06Q 20/20; G06Q 30/02

(52) U.S. Cl. CPC G06Q 20/201; G06Q 30/0206; G06Q 30/0223; G06Q 20/207

(57) ABSTRACT

A payment system is provided that modifies a transaction amount at a point of sale. The payment system includes an input that receives transaction data including transaction items and a transaction payment type and a custom fee module that adds a custom fee amount to the transaction amount at the point of sale, the custom fee amount being based on the transaction items and including at least one of a flat rate custom fee and a percentage-based custom fee. A discount module is provided that subtracts a discount amount from the transaction amount at the point of sale when the transaction items or the transaction payment type trigger a discount and calculates a total amount due at the point of sale to include the transaction amount, the custom fee amount, and the discount amount.

### CROSS-REFERENCE TO RELATED APPLICATIONS

This application claims priority to U.S. Provisional Application 62/752,810, filed on Oct. 30, 2018, the complete disclosure of which is incorporated herein by reference in its entirety.

### FIELD OF THE TECHNOLOGY

The technology relates to payment systems. More particularly, the technology relates to payment systems that adjust item prices at the point of sale.

### BACKGROUND OF THE TECHNOLOGY

Certain industries sell goods and services at prices that are impacted by market forces. For example, farmers may sell citrus products to retailers at wholesale prices that increase or decrease based on tightening or loosening supply conditions. Currently, retailers employing existing payment systems are not able to adjust item prices at a point of sale to compensate for price fluctuations. Instead, existing payment systems include item prices that remain constant for set periods of time, regardless of price fluctuations. These price fluctuations may be temporary such as when shippers add fuel surcharges to normal shipping prices or when couriers add surcharges for delivering during peak holiday times. Existing payment systems are not able to adjust prices for goods and/or services at the point of sale to account for price fluctuations.

Additionally, merchants or retailers may incur increased labor-related costs such as increased payroll costs, increased health insurance premiums, and/or increased compliance and licensing fees. Existing payment systems do not allow merchants to adjust prices for individual goods and/or services at the point of sale to compensate for variations in labor-related costs. For at least these reason, existing payment systems are deficient.

### BRIEF DESCRIPTION OF THE DRAWINGS

The accompanying drawings, that are incorporated in and constitute a part of this specification, illustrate several embodiments of the disclosure and, together with the description, server to explain the principles of the disclosure:

FIG. 1 illustrates a payment system according to one example of the technology;

FIG. 2A illustrates a process that allows sellers to modify an amount charged for goods and services at the point of sale according to one example of the technology;

FIG. 2B illustrates a continuation of the process that allows sellers to modify an amount charged for goods and services at the point of sale according to one example of the technology;

FIG. 3 illustrates a receipt generated according to the process of FIGS. 2A and 2B;

FIG. 4 illustrates a receipt for a debit card transaction generated according to the process of FIGS. 2A and 2B;

FIG. 5 illustrates a receipt for a cash transaction generated according to the process of FIGS. 2A and 2B.

### DETAILED DESCRIPTION OF THE TECHNOLOGY

The technology employs a payment system that overcomes the deficiencies of existing payment systems. According to one example, the payment system may operate in conjunction with a credit card or debit card a point of sale (POS) system, an online website, a smartphone, a terminal, or the like. This description includes specific details that are set forth in order to provide a thorough understanding of the examples described herein. It will be understood by those of ordinary skill in the art that the examples described herein can be practiced without these specific details. In other instances, methods, procedures, and components have not been described in detail so as not to obscure the related relevant feature being described. Also, the description is not to be considered as limiting the scope of the examples described herein. The drawings are not necessarily to scale and proportions of certain parts may have been exaggerated to better illustrate details and features of the present disclosure. Those skilled in the art with access to the teachings provided herein will recognize additional modifications, applications, and examples within the scope thereof and additional fields in which the technology may be of significant utility. It will be appreciated that for simplicity and clarity of illustration, where appropriate, reference numerals may be repeated among the different figures to indicate corresponding or analogous elements.

Unless defined otherwise, technical and scientific terms used herein have the same meaning as is commonly understood by one of ordinary skill in the art to which this disclosure belongs. The terms “first,” “second,” and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and means either, any, several, or all of the listed items. The terms “comprising,” “including” and “having” are used interchangeably in this disclosure. The terms “comprising,” “including” and “having” mean to include, but not necessarily be limited to the things so described.

The terms “connected” and “coupled” are not restricted to physical or mechanical connections or couplings, and can include electrical connections or couplings, whether direct or indirect. The connection can be such that the objects are permanently connected or releasably connected. The term “communicatively coupled” is defined as connected, either directly or indirectly through intervening components, and the connections are not necessarily limited to physical connections, but are connections that accommodate the transfer of data, signals, or other matter between the so-described components. The term “substantially” is defined to be essentially conforming to the thing that it “substantially” modifies, such that the thing need not be exact. For example, substantially real-time means that the occurrence may happen without noticeable delay but may include a slight delay.

The terms “circuit,” “circuitry,” and “controller” may include either a single component or a plurality of components, which are either active and/or passive components and may be optionally connected or otherwise coupled together to provide the described function. The “processor” described in any of the various embodiments includes an electronic circuit that can make determinations based upon inputs and is interchangeable with the term “controller.” The processor can include a microprocessor, a microcontroller, and a central processing unit, among others, of a general-purpose computer, special purpose computer, ASIC, or other programmable data processing apparatus. One of ordinary skill in the art will readily appreciate that computers may run any number of operating systems. While a single processor can be used, the present disclosure can be implemented over a plurality of processors. Computers may include point-of-sale devices, workstations, desktops, laptops, handheld computers, smartphones, smartwatches, or the like. According to one example, the computers may employ a computer operating system known to those of ordinary skill in the art.

A “server” described in any of the various examples includes hardware and/or software that provides processing, database, and communication facilities. By way of example, and not limitation, “server” may refer to a single, physical processor with associated communications, data storage, and database facilities. Additionally, “server” may refer to a networked or clustered complex of processors and associated network and storage devices, as well as operating software and one or more database systems and applications software that support the services provided by the server.

For the purposes of this disclosure, a computer readable medium stores computer data in machine readable form. By way of example, and not limitation, the computer readable medium may include computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium that may be used to store the desired information and which can be accessed by the computer.

This description references block diagrams and operational illustrations of methods and devices that process financial transactions using cash, stored value card, cryptocurrency, check, credit card, debit card, mobile payments, digital wallet services, or the like. It is understood that each block of the block diagrams or operational illustrations, and combinations of blocks in the block diagrams or operational illustrations, can be implemented with analog or digital hardware and computer program instructions. A processor may execute the computer program instructions to implement the functions/acts specified in the block diagrams or operational block or blocks. The computer program instructions may be compiled from computer programs created using a variety of known programming languages including, without limitation, Java™, C, C++, Visual Basic, Java Script, Perl, or the like, either alone or in combination. Generally, a processor receives instructions from a memory, a computer-readable medium, or the like, and executes these instructions to perform one or more processes. Such instructions and other data may be stored and transmitted using a variety of known computer-readable media. In some alternative implementations, the functions/acts noted in the blocks may occur out of the order depicted in the operational illustrations. For example, two blocks shown in succession may in fact be executed substantially concurrently or the blocks may sometimes be executed in reverse order, depending upon the functionality/acts involved.

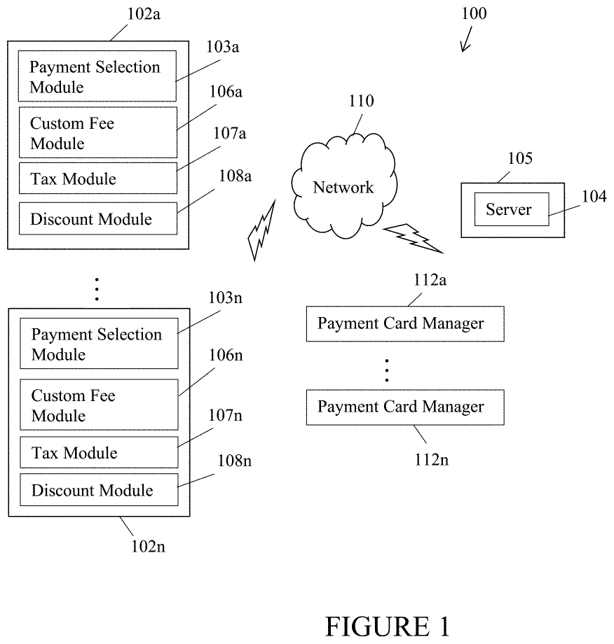

FIG. 1 illustrates a payment system 100 according to one example of the technology that allows buyers and sellers to participate in financial transactions based in cash, stored value card, cryptocurrency, check, credit card, debit card, or the like. Additionally, the payment system 100 allows buyers to submit mobile payments using devices having near-field communication (NFC) chips, for example. According to one example, the payment system 100 may include a POS system 102 that includes a desktop computer, a touch screen monitor, a cash drawer, a bar code scanner, a chip reader, a magnetic strip reader, an NFC reader, and a receipt printer, among other components. Alternatively, the POS system 102 may include a single integrated device that performs multiple functions. Still further, the POS system 102 may include a computer that is communicatively coupled to the Internet to allow buyers to purchase goods or services through a website. For example, buyers may access a payment portal through a website to submit payment information associated with a stored value card, a cryptocurrency, a checking account, a credit card, a debit card, or other payment information.

According to one example, the POS system 102 may be configured to process cash transactions and payment card transactions such as credit card and debit card transactions. According to one example, the POS system 102 may be configured to execute computer program instructions that implement the functions/acts of a payment selection module 103, a custom fee module 106, a tax module 107, and a discount module 108, among other modules.

According to one example, the payment system 100 may include a server 104 that is communicatively coupled to one or more POS systems 102a-102n (hereinafter “POS systems 102”). According to one example, the POS systems 102 may be associated with tens, hundreds, or thousands of merchants or sellers. According to one example, the server 104 may include a single, on-site server that aggregates transaction data received from the POS systems 102. According to one example, the transaction data may include financial transaction data. According to one example, the POS systems 102 may be associated with a physical location. For example, the physical location may include a commercial location such as a store, restaurant, medical facility, professional facility, exercise facility, among other commercial location. According to another example, the server 104 may include an off-site server that aggregates transaction data received from the POS systems 102. According to one example, the off-site server may communicate with POS systems 102 associated with one physical location. Alternatively, the off-site server may communicate with POS systems 102 associated with an entity that controls two or more physical locations. Still further, the off-site server may communicate with POS systems 102 that are associated with two or more entities that control two or more physical locations. For example, the two or more entities may be associated with a single entity such as a payment processor that processes the transaction data.

According to one example, the payment system 100 may include a payment card database 105 that is communicatively coupled to the POS systems 102 via a network 110 such as the Internet, a cellular communications network, a private wide area network (“WAN”), a local area network (“LAN”), or any other suitable communications technology. The network 110 may be connected to the Internet via conventional routers and/or firewalls. The network 110 also may be connected to a common carrier wireless network such as a CDMA network, for example. Still further, the network 110 may be connected to a wide area network that is connected to the Internet. The network 110 may support a transmission control protocol/Internet protocol (TCP/IP) connection, for example, and may be accessed over a cellular communications channel, wi-fi, a wired connection, or the like. According to one example, the network 110 may be a packet network and may support an IP connection. According to one example, the network 110 may employ known protocols for transporting data such as hypertext transfer protocol (“HTTP”), transport control protocol (“TCP”), user datagram protocol (“UDP”), or the like.

According to one example, the network 110 may communicatively couple the payment card networks 112a-112n (hereinafter “payment card networks 112”) and the payment card database 105. According to one example, the payment card networks 112 may manage credit card data for Visa®, Mastercard®, American Express®, Discover®, or the like. Furthermore, the payment card networks 112 may manage debit card data for Visa®, Mastercard®, Star System®, or the like. Still further, the payment card networks 112 may manage gift cards for an issuer of the gift cards. According to one example, the payment card networks 112 may communicate with the payment card database 105 via the network 110 to authorize payment card transactions that originate from the POS system 102. According to one example, the payment card networks 112 may communicate with the payment card database 105 via the network 110 to settle payment card transactions, invoice cardholders, and the like. According to one example, the seller may pay fees for accepting payment cards such as an interchange fee to a bank that issues the payment card and a processing fee to a processor that handles a transaction on behalf of the bank that issues the payment card. According to one example, the fees may be percentage-based transaction fees.

According to one example, databases such as the payment card database 105 may include hardware and software configured to store, access, and retrieve transaction data, among other data. According to one example, the payment card database 105 may include a hierarchical database, a relational database management system (“RDBMS”), files in a file system, an application database provided in a proprietary format, or the like. According to one example, the payment card database 105 may be accessed through the network 110 using a computer with an operating system. According to one example, the RDBMS may use a Structured Query Language (“SQL”) in addition to a language that creates, stores, edits, and executes stored procedures such as a procedural language extension to SQL (“PL/SQL”).

According to one example, the POS systems 102 may include a payment selection module 103 having program instructions that determine whether a buyer tenders cash, stored value card, cryptocurrency, check, credit card, debit card, mobile payments, or the like. According to one example, the payment selection module 103 may prompt buyers to select a payment type. For example, the payment selection module 103 may render icons on a touch screen monitor that enable a user to select among payment options such as cash, stored value card, cryptocurrency, check, credit card, debit card, and mobile payment, or the like. According to one example, the payment selection module 103 may prompt buyers to select a desired payment type. Alternatively, the payment selection module 103 may determine a payment type through sensors such as a bar code scanner, a chip reader, a magnetic strip reader, an NFC reader, or the like.

According to one example, the POS systems 102 may include a custom fee module 106 having program instructions that modify an amount charged for goods and services at the point of sale. According to one example, the custom fee module 106 may include program instructions that prompt sellers or merchants to modify an amount charged for goods or services at a point of sale based on information obtained during or prior to checkout. According to one example, the custom fee module 106 may include program instructions that prompt sellers to add a custom fee to a bill or invoice. According to one example, the custom fee module 106 may include program instructions that automatically add a custom fee to the bill or invoice. For example, the custom fee may be a service charge, a fuel surcharge, a delivery fee, a gratuity fee, or the like, that is associated with select items. According to one example, the custom fee module 106 may include program instructions that automatically add a custom fee to the invoice at the point of sale when select items or a combination of select items are scanned for purchase. For example, the custom fee module 106 may communicate with a database that correlates selected items or combination of selected items with custom fees. According to one example, the custom fees may include transportation expenses, shipping expenses, storage expenses, assembly expenses, compliance expenses, among other custom fees. According to one example, the custom fee module 106 may include program instructions that adjust custom fees such as shipping expenses during checkout according to a dollar value of an order. For example, if a buyer purchases items that in the aggregate exceed a certain financial value, the custom fee module 106 may include program instructions that waive any shipping expenses on the transaction. Alternatively, if a buyer purchases items that in the aggregate fall within a certain financial value range, the custom fee module 106 may include program instructions that subsidize any shipping expenses on the transaction. Still further, if a buyer purchases items that in the aggregate fall below a certain financial value, the custom fee module 106 may include program instructions that add shipping expenses to the transaction. According to one example, the custom fee module 106 may include program instructions that prompt sellers to adjust the custom fee amount, if desired.

According to one example, the POS systems 102 may include a tax module 107 having program instructions that determine whether the custom fee is taxable to the transaction. According to one example, the tax module 107 may include program instructions that add the custom fee to a sales tax calculation if the custom fee is determined to be taxable to the transaction. Alternatively, the tax module 107 may include program instructions that exclude the custom fee from a sales tax calculation if the custom fee is determined to be non-taxable to the transaction. According to one example, the tax module 107 may include program instructions that determine the taxable or non-taxable status for the transaction based on criteria obtained from a taxing authority. According to one example, the tax module 107 may include program instructions that assign non-taxable status to certain custom fees of the transaction such as gratuities that are distributed as wages to restaurant service staff. Alternatively, the tax module 107 may include program instructions that assign taxable status to certain custom fees of the transaction such as food sales that are distributed as profit to the business.

According to one example, the POS systems 102 may include a discount module 108 with computer executable program instructions that deduct a financial amount from a buyer's bill or invoice in the form of a discount. According to one example, the discount module 108 may include program instructions that offer discounts to buyers who purchase a combination of goods and/or services. According to one example, the discount module 108 may communicate with a database that correlates selected items or combinations of selected items with financial discounts. According to one example, the discount module 108 may include program instructions that bundle certain goods and/or services together and may offer discounts on the combination of bundled items. For example, the discount module 108 may include program instructions that automatically deduct a discount from a bill or invoice when select items or combinations of selected items are purchased. According to one example, the discount module 108 may include program instructions that bundle together certain goods and/or services based on pre-selected criteria such as item price, expiration date, days in store, item type, item manufacturer, or the like. According to one example, the discount may exceed the custom fee amount.

According to one example, item manufacturers may promote bundled items by offering discounts when items are purchased together. Alternatively, item manufacturers may promote expiring items by offering discounts when expiring items are purchased. According to one example, the discount module 108 may include program instructions that obtain financial discounts from a database associated with a grocery store. For example, the discount module 108 may include program instructions that obtain financial discounts for expiring dairy items. In this case, a grocery store may advertise financial discounts for expiring dairy items proximate to the product placement and the discount module 108 may apply any discounts during checkout.

According to one example, the discount module 108 may include program instructions that offer percentage-based discounts or fixed discounts in order to motivate buyers to purchase the bundled goods and/or services. According to one example, the discount module 108 may apply discounts toward the purchase of bundled items and may charge non-discounted amounts toward the purchase of exempted items as described further below. According to one example, the discount module 108 may include program instructions that offer discounts for payments made using discount eligible payment options. For example, the discount module 108 may include program instructions that provide a 2% discount for cash payments and/or a fixed $1 discount for stored value card payments. According to one example, the discount module 108 may include program instructions that automatically deduct a discount depending on a payment type tendered during checkout such as cash, stored value card, cryptocurrency, check, credit card, debit card, or the like. For example, the discount module 108 may include program instructions that deduct a transaction-based fee from an amount charged by sellers for goods and services based on use of certain payment types such as stored value card payments. The transaction-based fee may include a processing fee that is paid to a payment processor who handles a transaction on behalf of a seller or merchant.

According to one example, the discount module 108 may include program instructions that calculate the processing fee as a percentage of a transaction value. In contrast, payment types such as cash, check, or cryptocurrency payment types may not include similar transaction fees. According to one example, the discount module 108 may include program instructions that apply a discount for payments made using payment types such as cash, check, or cryptocurrency. Furthermore, the discount module 108 may include program instructions that apply a discount for payments made using stored value card. According to one example, the discount module 108 may include program instructions that provide a larger discount for payments made using cash or check as opposed to payments made using stored value card. According to one example, the discount module 108 may include program instructions that calculate a total amount due on an invoice based on an item total amount, a discount amount, a custom fee amount, a subtotal amount, and a tax amount, among other transaction amounts.

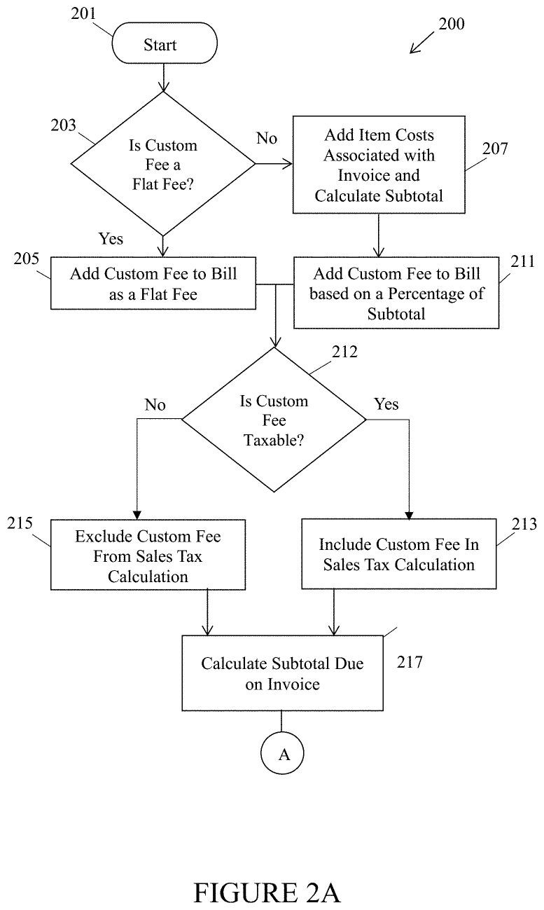

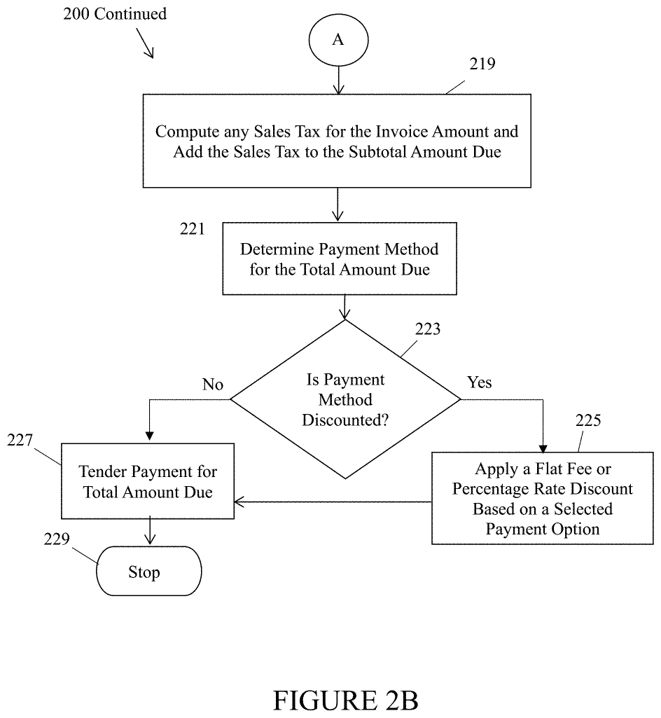

FIGS. 2A and 2B illustrate a flow chart according to one example of the technology. At operation 201, the POS system 102 starts a custom payment program. For example, the custom payment program may be triggered during a checkout procedure. At operation 203, the custom fee module 106 determines whether a custom fee is a flat fee. According to one example, a decision regarding whether the custom fee is a flat fee may be determined by a type of service performed or a type of good purchased. If the custom fee is a flat fee, then the custom fee module 106 may add the flat fee to the invoice in operation 205. Alternatively, if the custom fee is not determined to be a flat fee, then the custom fee module 106 identifies the custom fee as a percentage-based fee and, in operation 207, adds together item costs associated with the invoice to calculate a purchase amount subtotal. In operation 209, the custom fee module 106 adds a custom fee to the invoice as a percentage of the purchase amount subtotal.

In operation 212, the tax module 107 may determine whether the custom fee is taxable to the transaction. For example, the tax module 107 may identify one or more categories associated with the custom fee and may rely on the category to determine whether the custom fee is taxable to the transaction. For example, in a restaurant industry, if the custom fee is related to an employee gratuity expense, then the custom fee is categorized as non-taxable to the transaction. Alternatively, if the custom fee is related to a corporate expense, then the custom fee may be categorized as taxable to the transaction. According to yet another example, the tax module 107 may identify the custom fee as a blend of employee-related expense and corporate-related expense. In this case, the tax module 107 may categorize a percentage of the custom fee as non-taxable to the transaction and a remaining percentage of the custom fee as taxable to the transaction.

In operation 213, the tax module 107 may include the custom fee in a sales tax calculation. In operation 215, the tax module 107 may exclude the custom fee from a sales tax calculation. According to one example, the tax module 107 may provide transaction-level reporting that includes both a custom fee amount and any sales tax amount associated with the custom fee amount. In operation 217, the POS system 102 may calculate a subtotal that is due on the invoice. According to one example, the subtotal due may include or exclude sales tax. According to one example, the subtotal due on the invoice may include a subtotal of all item costs associated with the invoice, any custom fees added, and any discounts that are applied such as a buy one get one (“BOGO”) free discount, a 3-for-1 discount, or the like. According to one example, selected items may not be eligible for discounts when item manufacturers, item regulators, or others prohibit discount offerings.

FIG. 2B is a continuation of the flow chart illustrated in FIG. 2A. In operation 219, the POS system 102 computes any sales tax due on the invoice amount and may add the sales tax amount to the subtotal amount in order to determine a total amount due. According to one example, the POS system 102 may recalculate any sales taxes based on any price changes in the subtotal after a discount. For example, a discount may be associated with payment options such as cash, check, debit card, or the like. According to one example, any reduction in a subtotal amount due may have an impact on the computation of sales taxes. In operation 221, the POS system 201 determines a payment method for the total amount due. According to one example, a total amount due may change dynamically during the checkout process based on selection of a discount payment type.

In operation 223, the POS system 102 determines whether a selected payment option includes a discount. For example, the POS system 102 may provide discounts for using cash, stored value gift card, cryptocurrency, check, credit card, debit card, or the like. During checkout, an operator may select among various payment options programmed into the POS system 102. According to one example, the payment selection module 103 may render on a display one or more payment options associated with a discount. According to one example, the payment selection module 103 allows users to select payment options associated with a discount. For example, the payment selection module 103 may offer percentage-based discounts when buyers tendering cash. Alternatively, the payment selection module 103 may offer a fixed discount when buyers tender a stored value card. According to one example, the payment selection module 103 may offer a fixed discount amount, a percentage-based discount amount, or a combination of both.

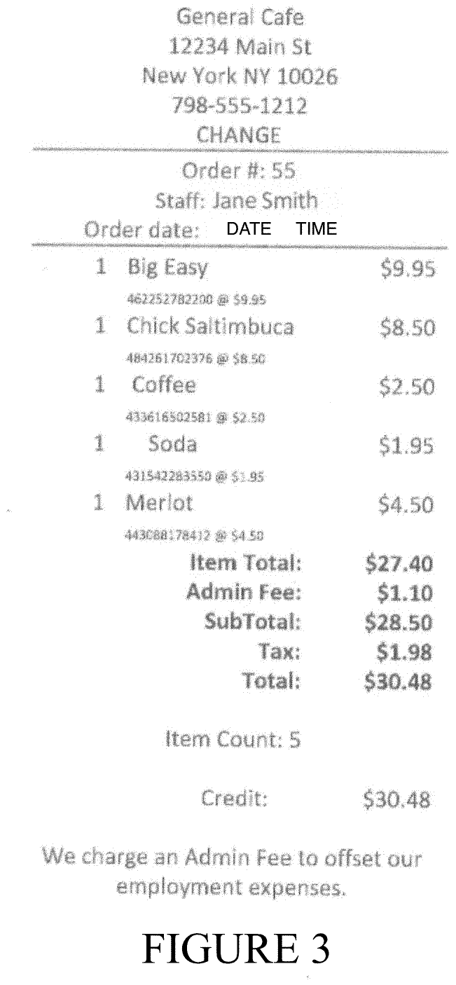

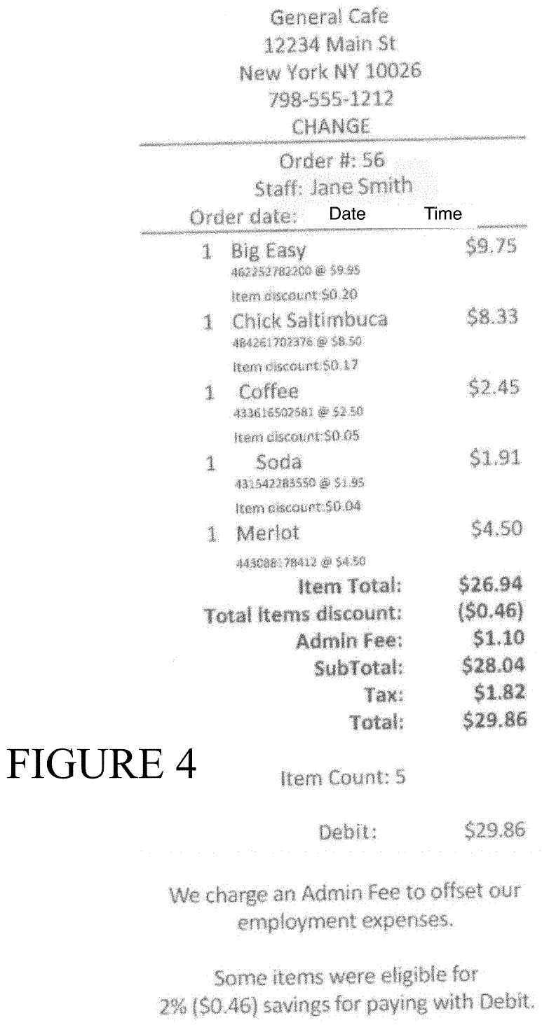

According to one example, the POS system 102 may display discounts on an item-by-item basis. For example, FIG. 4 illustrates a receipt having five (5) items, with four (4) items being discounted. According to one example, the discount module 108 may allocate ¼ of the available fixed discount amount to each eligible item. Alternatively, a fixed discount amount may be proportionally allocated to each eligible item. With reference to FIG. 3, the total item amount eligible for discount is $22.90, based on full prices for (1) the big easy at $9.95; (2) the chick saltimbuca at $8.50; (3) the coffee at $2.50; and (4) the soda at $1.95. According to one example, the big easy may receive a proportional discount amount of $9.95/$22.90 or 43%; the chick saltimbuca may receive a proportional discount amount of $8.50/$22.90 or 37%; the coffee may receive a proportional discount amount of $2.50/$22.90 or 11%; and the soda may receive a proportional discount amount of $1.95/$22.90 or 9%. One of ordinary skill in the art will readily appreciate that the discount may be applied to eligible items in other ways.

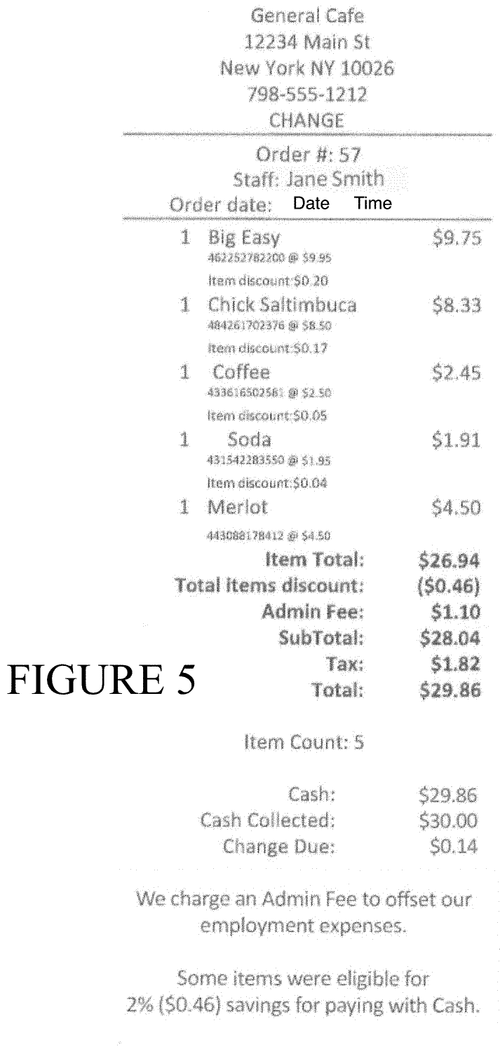

FIGS. 4 and 5 illustrate invoices where the merlot wine is purchased at full price, without discount. According to one example, the discount module 108 may be programmed to prohibit offering discounts on alcoholic beverages due to state and federal regulations. Furthermore, the discount module 108 may identify certain items as not being eligible for discount if manufacturers, regulators, or others prohibit discounts. Still further, the discount module 108 may identify certain items as not being eligible for discount if specific manufacturers prohibit discounts on particular brands. Accordingly, the discount module 108 may be programmed to render certain items ineligible for discounts.

In operation 225, the POS system 102 calculates a subtotal amount, which may be discounted by a percentage rate and/or a flat fee depending on the selected payment option. According to one example, the discount module 108 may apply a unique discount amount to the payment options such that a custom discount is associated with the payment options. Alternatively, the discount module 108 may apply a common discount amount to the payment options such that a same discount is offered for any payment option tendered by a buyer or customer. As an example, if an invoice shows a total amount due of $100 and a buyer selects a personal check for payment, the discount module 108 may determine that the transaction is eligible for a 2% discount off a subtotal before tax. In this case, a subtotal for each eligible item may be reduced by 2% and the sales tax due may be simultaneously recalculated to render a new total amount due for the selected payment option.

According to one example, the POS system 102 may recalculate any sales tax due after a discount is computed. The POS system 102 may calculate a new amount for a total amount due based upon the selected payment option. In this case, the selected payment option is used to determine the new total amount due. In operation 227, the POS system 102 may accept payment for the amount due. Otherwise, in operation 227, the POS system 102 may accept payment for an amount due if a payment option is not associated with a discount. According to one example, FIGS. 3-5 illustrate that receipts may include a printed message stating whether or not a discount was applied.

FIGS. 3-5 illustrate examples of receipts according to the technology. FIG. 3 illustrates a receipt issued by a café that includes several food items and corresponding prices, which are added together to render a total amount due. According to one example, the receipt includes a custom fee in the form of an administrative fee and does not include a discount. The receipt also includes a subtotal that is derived from the item total and the administrative fee. The receipt further includes a tax amount that is added to the subtotal to render a total amount due. According to one example, the receipt may include text printed near the bottom that states an administrative fee is added to offset employment expenses.

According to another example, FIG. 4 illustrates a receipt issued by a café that includes several food items and corresponding prices. According to one example, certain food items are individually discounted based on payment by debit card. The full price food item and the individually discounted food items are added together to render an item total. The receipt includes a custom fee in the form of an administrative fee and a total items discount based on payment by debit card. The receipt also includes a subtotal that is derived from the item total, the administrative fee, and the total items discount that is calculated from individually discounted items. The receipt further includes a tax amount that is added to the subtotal to render a total amount due. The receipt includes text printed near the bottom stating that some items were eligible for 2.00% ($0.46) savings due to payment by debit card and that an administrative fee is added to offset employment expenses.

FIG. 5 illustrates yet another receipt issued by a café that includes several food items and corresponding prices, some of the food items being individually discounted based on payment by cash. The full price food item and the individually discounted food items are added together to render an item total. The receipt includes a custom fee in the form of an administrative fee and a total items discount amount based on payment by cash. The receipt also includes a subtotal that is derived from the item total, the administrative fee, and the total items discount amount that is calculated from individually discounted items. The receipt further includes a tax amount that is added to the subtotal to render a total amount due. The receipt includes text printed near the bottom that states some items were eligible for 2.00% ($0.46) savings for paying with cash and further states that an administrative fee is added to offset employment expenses.

Examples are described above with the aid of functional building blocks that illustrate the implementation of specified functions and relationships thereof. The boundaries of these functional building blocks have been arbitrarily defined herein for the convenience of the description. Alternate boundaries can be defined so long as the specified functions and relationships thereof are appropriately performed. While the foregoing illustrates and describes examples of this technology, it is to be understood that the technology is not limited to the constructions disclosed herein. The technology may be embodied in other specific forms without departing from its spirit. Accordingly, the appended claims are not limited by specific examples described herein.

What is claimed is:

1. A method of modifying a transaction amount at a point of sale, the method comprising:
receiving, via a processor, transaction data including transaction items and a transaction payment type;
applying a custom fee amount to add to the transaction amount at the point of sale, the custom fee amount being based on the transaction items and including at least one of a flat rate custom fee and a percentage-based custom fee;
subtracting a discount amount from the transaction amount at the point of sale when the transaction items or the transaction payment type trigger a discount; and
calculating a total amount due at the point of sale to include the transaction amount, the custom fee amount, and the discount amount.

2. The method of claim 1, further comprising determining whether the custom fee amount is taxable or non-taxable to the transaction; and
adding the custom fee amount to the total amount due when taxable or excluding the custom fee amount from the total amount due when non-taxable.

3. The method of claim 1, wherein the custom fee amount corresponds to at least one of a service charge, a fuel surcharge, a delivery fee, and a gratuity fee.

4. The method of claim 1, wherein the discount is triggered by two or more of the transaction items purchased in combination.

5. The method of claim 1, wherein the discount exceeds the custom fee amount.

6. The method of claim 1, wherein the discount includes at least one of a percentage-based discount and a fixed discount.

7. The method of claim 1, wherein the discount is triggered when the payment type includes at least one of cash, stored value card, cryptocurrency, and check.

8. A non-transitory computer-readable storage medium having stored therein instructions which, when executed by a microprocessor, causes the payment system to:
receive, via a processor, transaction data including transaction items and a transaction payment type;
apply a custom fee amount to add to the transaction amount at the point of sale, the custom fee amount being based on the transaction items and including at least one of a flat rate custom fee and a percentage-based custom fee;
subtract a discount amount from the transaction amount at the point of sale when the transaction items or the transaction payment type trigger a discount; and
calculate a total amount due at the point of sale to include the transaction amount, the custom fee amount, and the discount amount.

9. The non-transitory computer-readable storage medium of claim 8, further comprising instructions which, when executed by the microprocessor, causes the payment system to:
determine whether the custom fee amount is taxable or non-taxable to the transaction; and
add the custom fee amount to the total amount due when taxable or exclude the custom fee amount from the total amount due when non-taxable.

10. The non-transitory computer-readable storage medium of claim 8, wherein the instructions, when executed by the microprocessor, causes the payment system to associate the custom fee with at least one of a service charge, a fuel surcharge, a delivery fee, and a gratuity fee.

11. The non-transitory computer-readable storage medium of claim 8, wherein the instructions, when executed by the microprocessor, causes the payment system to trigger the discount by purchasing two or more of the transaction items in combination.

12. The non-transitory computer-readable storage medium of claim 8, wherein the instructions, when executed by the microprocessor, causes the payment system to apply the discount to include at least one of a percentage-based discount and a fixed discount.

13. The non-transitory computer-readable storage medium of claim 8, wherein the instructions, when executed by the microprocessor, causes the payment system to trigger the discount when the payment type includes at least one of cash, stored value card, cryptocurrency, and check.

14. A payment system that modifies a transaction amount at a point of sale, the payment system comprising:
an input that receives transaction data including transaction items and a transaction payment type;
a custom fee module that adds a custom fee amount to the transaction amount at the point of sale, the custom fee amount being based on the transaction items and including at least one of a flat rate custom fee and a percentage-based custom fee; and
a discount module that subtracts a discount amount from the transaction amount at the point of sale when the transaction items or the transaction payment type trigger a discount and calculates a total amount due at the point of sale to include the transaction amount, the custom fee amount, and the discount amount.

15. The payment system according to claim 14, further comprising a tax module that determines whether the custom fee amount is taxable or non-taxable to the transaction and adds the custom fee amount to the total amount due when taxable or excludes the custom fee amount from the total amount due when non-taxable.

16. The payment system according to claim 14, wherein the custom fee module associates the custom fee amount with at least one of a service charge, a fuel surcharge, a delivery fee, and a gratuity fee.

17. The payment system according to claim 14, wherein the discount module triggers the discount when two or more of the transaction items are purchased in combination.

18. The payment system according to claim 14, wherein the discount exceeds the custom fee amount.

19. The payment system according to claim 14, wherein the discount module employs at least one of a percentage-based discount and a fixed discount.

20. The payment system according to claim 14, wherein the discount module triggers the discount when the payment type includes at least one of cash, stored value card, cryptocurrency, and check.
